(19) United States
(12) Patent Application Publication
(10) Pub. No.: US 2024/0385650 A1
(43) Pub. Date: Nov. 21, 2024

(54) BATTERY AND ELECTRONIC DEVICE INCLUDING SAME

(71) Applicant: Samsung Electronics Co., Ltd., Suwon-si (KR)

(72) Inventors: Sihoon YOUM, Suwon-si (KR); Bongjae KIM, Suwon-si (KR); Jephil SHIN, Suwon-si (KR)

(21) Appl. No.: 18/787,262

(22) Filed: Jul. 29, 2024

Related U.S. Application Data
(63) Continuation of application No. PCT/KR2022/011699, filed on Aug. 5, 2022.

(30) Foreign Application Priority Data
Jan. 28, 2022 (KR) 10-2022-0013138
Mar. 17, 2022 (KR) 10-2022-0033084

(51) Int. Cl. G06F 1/16; G06F 1/18; H01M 50/244; H01M 50/247

(52) U.S. Cl. CPC G06F 1/1635; G06F 1/1616; G06F 1/183; H01M 50/244; H01M 50/247; H01M 2220/30

(57) ABSTRACT

An electronic device is provided. The electronic device includes a housing, a display disposed at the housing, a support member disposed in the housing, a battery disposed on the support member and including a first surface facing the display, a second surface facing in the opposite direction to the first surface, and a side surface disposed between the first surface and the second surface, a first attachment member disposed on a first region of the first surface and fixing the battery to the support member, a second attachment member including a first portion disposed on a second region of the first surface and a second portion disposed to surround at least a portion of the side surface, wherein the battery includes at least one bent region which extends from the first surface of the battery and is curved toward the display.

### CROSS-REFERENCE TO RELATED APPLICATION(S)

This application is a continuation application, claiming priority under § 365 (c), of an International application No. PCT/KR2022/011699, filed on Aug. 5, 2022, which is based on and claims the benefit of a Korean patent application number 10-2022-0013138, filed on Jan. 28, 2022, in the Korean Intellectual Property Office, and of a Korean patent application number 10-2022-0033084, filed on Mar. 17, 2022, in the Korean Intellectual Property Office, the disclosure of each of which is incorporated by reference herein in its entirety.

### BACKGROUND

### 1. Field

The disclosure relates to an electronic device. More particularly, the disclosure relates to a battery and an electronic device including the same.

### 2. Description of Related Art

The growth of electronics, information, and communication technologies leads to integration of various functions into a single electronic device. For example, smartphones pack the functionalities of a sound player, imaging device, and scheduler, as well as the communication functionality and, on top of that, may implement more various functions by having applications installed thereon. An electronic device may not only its equipped applications or stored files but also access, wiredly or wirelessly, a server or another electronic device to receive, in real-time, various pieces of information. The trend of routinely carrying and using an electronic device by the user for a longer time leads to the need for a larger-capacity battery.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a battery and electronic device including same.

Additional aspects will be set forth in part in the description which follows and, in part, will be apparent from the description, or may be learned by practice of the presented embodiments.

In accordance with an aspect of the disclosure, an electronic device is provided. The electronic device includes a housing, a display disposed at the housing, a supporting member disposed in the housing, a battery disposed on the supporting member and including a first surface facing the display, a second surface facing in a direction opposite to the first surface, and a side surface disposed between the first surface and the second surface, a first attachment member disposed on a first area of the first surface to fix the battery to the supporting member, and a second attachment member including a first portion disposed on a second area of the first surface and a second portion disposed to surround at least a portion of the side surface, wherein the battery includes at least one bending area extending from the first surface of the battery and bent toward the display.

In accordance with another aspect of the disclosure, a battery is provided. The battery includes a first surface, a second surface facing in a direction opposite to the first surface, a side surface between the first surface and the second surface, a first attachment member disposed in a first area of the first surface, a second attachment member including a first portion disposed in a second area of the first surface and a second portion disposed to surround at least a portion of the side surface, and at least one bending area extending from the first surface and bent toward the second surface.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a view illustrating an unfolded state of an electronic device according to an embodiment of the disclosure;

FIG. 3 is a view illustrating a folded state of an electronic device according to an embodiment of the disclosure;

FIG. 4 is an exploded perspective view illustrating an electronic device according to an embodiment of the disclosure;

FIG. 5 is a plan view illustrating a supporting member and a battery according to an embodiment of the disclosure;

FIG. 6 is a cross-sectional view illustrating the battery of FIG. 5, taken along B-B′ according to an embodiment of the disclosure;

FIG. 7 is a cross-sectional view illustrating the battery of FIG. 5, taken along C-C′ according to an embodiment of the disclosure;

FIG. 8 is a bottom view illustrating a battery according to an embodiment of the disclosure;

FIG. 9A is a perspective view illustrating a portion of a battery according to an embodiment of the disclosure;

FIG. 9B is a plan view illustrating a portion of a battery according to an embodiment of the disclosure;

FIG. 10A is a perspective view illustrating a portion of a battery according to an embodiment of the disclosure; and

FIG. 10B is a perspective view illustrating another portion of a battery according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

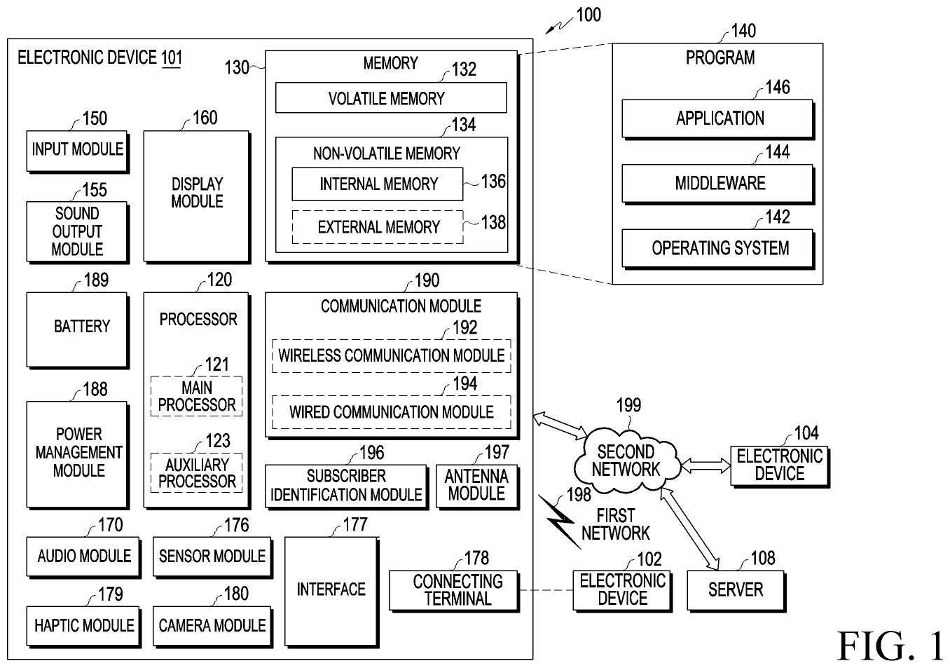

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment of the disclosure, at least one (e.g., the connecting terminal 178) of the components may be omitted from the electronic device 101, or one or more other components may be added in the electronic device 101. According to an embodiment of the disclosure, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor configured to detect a touch, or a pressure sensor configured to measure the intensity of a force generated by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth-generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment of the disclosure, the antenna module may include an antenna including a radiator formed of a conductor or conductive pattern formed on a substrate (e.g., a printed circuit board (PCB)). According to an embodiment of the disclosure, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment of the disclosure, other parts (e.g., radio frequency integrated circuit (RFIC)) than the radiator may be further formed as part of the antenna module 197.

According to an embodiment of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

According to an embodiment of the disclosure, each component (e.g., a module or a program) of the above-described components may include a single entity or multiple entities. Some of the plurality of entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

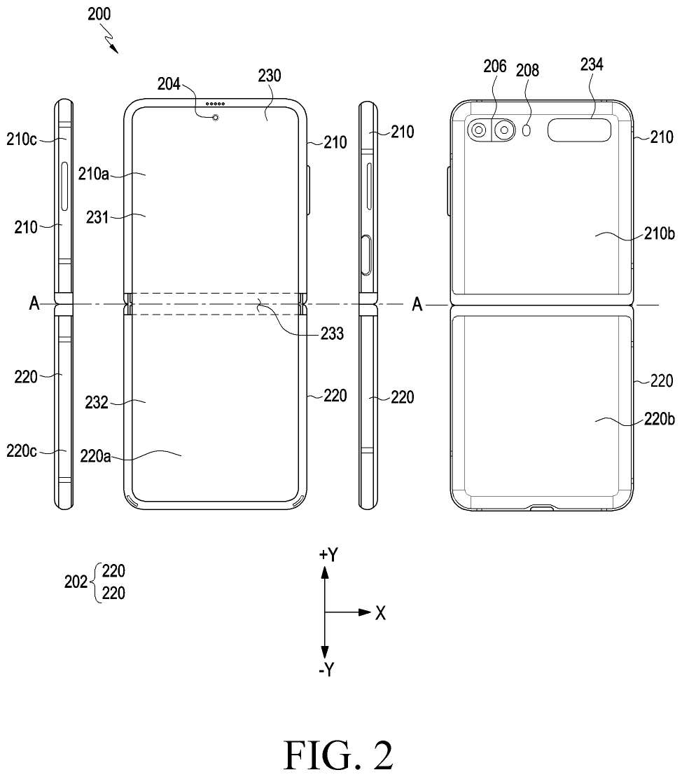

FIG. 2 is a view illustrating an unfolded state of an electronic device according to an embodiment of the disclosure.

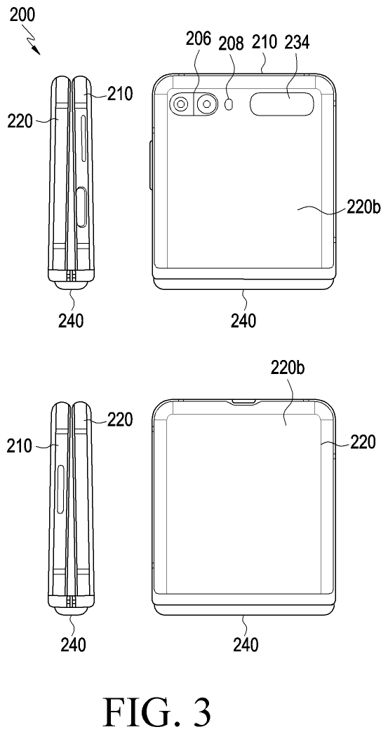

FIG. 3 is a view illustrating a folded state of an electronic device according to an embodiment of the disclosure.

Referring to FIGS. 2 and 3, a configuration of an electronic device 200 of FIGS. 2 and 3 may be identical in whole or part to the configuration of the electronic device 201 of FIG. 1.

The electronic device 200 may include a housing 202 for receiving a component (e.g., a hinge structure 280 of FIG. 3) of the electronic device 200 and a flexible display or foldable display (hereinafter, a display 230) disposed in the space formed by the housing 202. According to an embodiment of the disclosure, the housing 202 may be referred to as a foldable housing.

According to an embodiment of the disclosure, the housing 202 may include a first housing 210 and a second housing 220 configured to rotate about the first housing 210.

According to an embodiment of the disclosure, the first housing 210 and/or the second housing 220 may form a portion of the exterior of the electronic device 200. According to an embodiment of the disclosure, the surface where the display 230 is visually exposed is defined as a front surface (e.g., a first front surface 210a and a second front surface 220a) of the electronic device 200 and/or housing 202. A surface opposite to the front surface is defined as a rear surface (e.g., the first rear surface 210b and a second rear surface 220b) of the electronic device 200. A surface surrounding at least a portion of the space between the front surface and the rear surface is defined as a side surface (e.g., the first side surface 210c and the second side surface 220c) of the electronic device 200.

According to an embodiment of the disclosure, the first housing 210 may be rotatably connected to the second housing 220 by a hinge structure (e.g., the hinge structure 280 of FIG. 3). For example, the first housing 210 and the second housing 220 may be connected to each other to be rotatable about the hinge structure 280. Thus, the electronic device 200 may turn into a folded state (e.g., FIG. 3) or unfolded state (e.g., FIG. 2). In the folded state of the electronic device 200, the first front surface 210a may face the second front surface 220a and, in the unfolded state, the direction in which the first front surface 210a faces may be the same as the direction in which the second front surface 220a faces. For example, in the unfolded state, the first front surface 210a may be positioned on substantially the same plane as the second front surface 220a. According to an embodiment of the disclosure, the second housing 220 may provide a motion relative to the first housing 210.

According to an embodiment of the disclosure, the first housing 210 and the second housing 220 are disposed on both sides of the folding axis A and be overall symmetrical in shape with respect to the folding axis A. The angle between the first housing 210 and the second housing 220 may be changed depending on whether the electronic device 200 is in the unfolded state, the folded state, or an intermediate state between the unfolded state and the folded state.

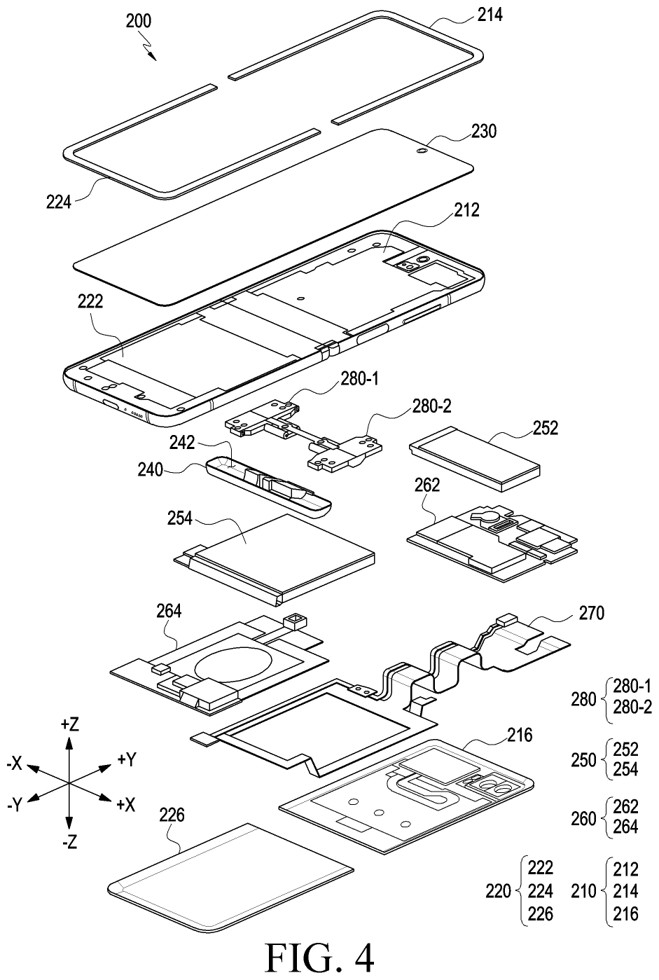

According to an embodiment of the disclosure, the electronic device 200 may include a hinge cover 240. At least a portion of the hinge cover 240 may be disposed between the first housing 210 and the second housing 220. According to an embodiment of the disclosure, the hinge cover 240 may be hidden by a portion of the first housing 210 and second housing 220 or be exposed to the outside depending on the state of the electronic device 200. According to an embodiment of the disclosure, the hinge cover 240 may protect the hinge structure (e.g., the hinge structure 280 of FIG. 4) from an external impact of the electronic device 200. According to an embodiment of the disclosure, the hinge cover 240 may be interpreted as a hinge housing for protecting the hinge structure 280.

According to an embodiment of the disclosure, as shown in FIG. 2, in the unfolded state of the electronic device 200, the hinge cover 240 may be hidden, and thus not exposed, by the first housing 210 and the second housing 220. As another example, as shown in FIG. 3, in the folded state (e.g., a fully folded state) of the electronic device 200, the hinge cover 240 may be exposed to the outside between the first housing 210 and the second housing 220. As another example, in an intermediate state in which the first housing 210 and the second housing 220 are folded with a certain angle, the hinge cover 240 may be partially exposed to the outside between the first housing 210 and the second housing 220. However, in this case, the exposed area may be smaller than that in the completely folded state. In an embodiment of the disclosure, the hinge cover 240 may include a curved surface.

According to an embodiment of the disclosure, the display 230 may visually provide information to the outside (e.g., the user) of the electronic device 200. The display 230 may include, for example, a hologram device, or a projector and control circuitry to control a corresponding one of the display, hologram device, and projector. According to an embodiment of the disclosure, the display 230 may include a touch sensor configured to detect a touch, or a pressure sensor configured to measure the intensity of a force generated by the touch.

According to an embodiment of the disclosure, the display 230 may mean a display at least a portion of which may be transformed into a flat or curved surface. For example, the display 230 may be formed to be transformable in response to the motion of the second housing 220 relative to the first housing 210. According to an embodiment of the disclosure, the display 230 may include a folding area 233, a first display area 231 disposed on one side of the folding area 233 (e.g., the upper (+Y) direction), and a second display area 232 disposed on the opposite side of the folding area 233 (e.g., lower (−Y) direction). According to an embodiment of the disclosure, the folding area 233 may be formed over the hinge structure (e.g., the hinge structure 280 of FIG. 4). For example, at least a portion of the folding area 233 may face the hinge structure 280. According to an embodiment of the disclosure, the first display area 231 may be disposed on the first housing 210, and the second display area 232 may be disposed on the second housing 220. According to an embodiment of the disclosure, the display 230 may be received in the first housing 210 and the second housing 220.

However, the segmentation of the display 230 as shown in FIG. 2 is merely an example, and the display 230 may be divided into a plurality of (e.g., four or more, or two) areas depending on the structure or function of the display 230.

Further, in the embodiment illustrated in FIG. 2, the area of the display 230 may be segmented by the folding area 233 or folding axis (axis A) extending in parallel with the X axis but, in another embodiment of the disclosure, the display 230 may also be segmented with respect to other folding area (e.g., a folding area parallel with the Y axis) or other folding axis (e.g., a folding axis parallel with the Y axis). According to an embodiment of the disclosure, the display 230 may be coupled with or disposed adjacent to a touch detection circuit, a pressure sensor capable of measuring the strength (pressure) of touches, and/or a digitizer for detecting a magnetic field-type stylus pen.

According to an embodiment of the disclosure, the electronic device 200 may include a rear display 234. The rear display 234 may be disposed to face in a different direction from the display 230. For example, the display 230 may be visually exposed through the front surface (e.g., the first front surface 210a and/or the second front surface 220a) of the electronic device 200, and the rear display 234 may be visually exposed through the rear surface (e.g., the first rear surface 210b) of the electronic device 200.

According to embodiments of the disclosure, the electronic device 200 may include at least one camera module 204 and 206 and a flash 208. According to an embodiment of the disclosure, the electronic device 200 may include a front camera module 204 exposed through the front surface (e.g., the first front surface 210a) and/or a rear camera module 206 exposed through the rear surface (e.g., the first rear surface 210b). The camera modules 204 and 206 may include one or more lenses, an image sensor, a flash, and/or an image signal processor. The flash 208 may include a light emitting diode (LED) or a xenon lamp. In an embodiment of the disclosure, two or more lenses (infrared camera, wide-angle and telephoto lens) and image sensors may be disposed on one surface of the electronic device 200. The configuration of the front camera module 204 and/or rear camera module 206 may be identical in whole or part to the configuration of the camera module 180 of FIG. 1.

FIG. 4 is an exploded perspective view illustrating an electronic device according to an embodiment of the disclosure.

Referring to FIG. 4, an electronic device 201 may include a first housing 210, a second housing 220, a display 230, a hinge cover 240, a battery 250, a printed circuit board 260, a flexible printed circuit board 270, and the hinge structure 280. The configuration of the first housing 210, the second housing 220, the display 230, and the hinge cover 240 of FIGS. 3 and 4 may be identical in whole or part to the configuration of the first housing 210, the second housing 220, the display 230, and the hinge cover 240 of FIG. 2 and/or 3.

According to an embodiment of the disclosure, the electronic device 200 may include a first supporting member 212 or a second supporting member 222. For example, the first housing 210 may include the first supporting member 212, and the second housing 220 may include a second supporting member 222. According to an embodiment of the disclosure, the first supporting member 212 and/or the second supporting member 222 may support components (e.g., the display 230, the battery 250, and the printed circuit board 260) of the electronic device 200.

According to an embodiment of the disclosure, the first supporting member 212 and/or the second supporting member 222 may be formed of a metal material and/or a non-metal (e.g., polymer) material. According to an embodiment of the disclosure, the first supporting member 212 may be disposed between the display 230 and the battery 250. For example, the display 230 may be coupled to one surface of the first supporting member 212, and the battery 250 and the printed circuit board 260 may be disposed on the other surface.

According to an embodiment of the disclosure, the electronic device 200 may include a first protection member 214 or a second protection member 224. For example, the first housing 210 may include the first protection member 214, and the second housing 220 may include a second protection member 224. According to an embodiment of the disclosure, the first protection member 214 and the second protection member 224 may protect the display 230 from external impact. For example, the first protection member 214 may surround at least a portion of a portion (e.g., the first display area 231 of FIG. 1) of the display 230, and the second protection member 224 may surround at least a portion of another portion (e.g., the second display area 232 of FIG. 1) of the display 230. According to an embodiment of the disclosure, the first protection member 214 may be referred to as a first deco member, and the second protection member 214 may be referred to as a second deco member.

According to an embodiment of the disclosure, the housings 210 and 220 may include a first rear plate 216 and a second rear plate 226. For example, the first housing 210 may include the first rear plate 216 connected to the first supporting member 212, and the second housing 220 may include the second rear plate 226 connected to the second supporting member 222. According to an embodiment of the disclosure, the first rear plate 216 and the second rear plate 226 may form at least a portion of the exterior of the electronic device 200. For example, the first rear plate 216 may form a first rear surface (e.g., the first rear surface 210b of FIG. 1), and the second rear plate 226 may form a second rear surface (e.g., the second rear surface 220b of FIG. 1). According to an embodiment of the disclosure, a first battery 252 and a first printed circuit board 262 may be disposed between the first supporting member 212 and the first rear plate 216. A second battery 254 and a second printed circuit board 264 may be disposed between the second supporting member 222 and the second rear plate 226.

According to an embodiment of the disclosure, the hinge cover 240 may receive at least a portion of the hinge structure 280. For example, the hinge cover 240 may include a receiving recess 242 for receiving the hinge structure 280. According to an embodiment of the disclosure, the hinge cover 240 may be coupled to the hinge structure 280. According to an embodiment of the disclosure, in the unfolded state of the electronic device 200, at least a portion of the hinge cover 240 may be positioned between the hinge structure 280 and the first housing 210 and the second housing 220.

According to an embodiment of the disclosure, the battery 250 may be a device for supplying power to at least one component of the electronic device 200. The battery 189 may include a primary cell which is not rechargeable, a secondary cell which is rechargeable, or a fuel cell. The battery 250 may be integrally or detachably disposed inside the electronic device 200. According to an embodiment of the disclosure, the battery 250 may include the first battery 252 disposed in the first housing 210 and the second battery 254 disposed in the second housing 220. For example, the first battery 252 may be disposed at a position corresponding to the first supporting member 212, and the second battery 254 may be disposed at a position corresponding to the second supporting member 222.

According to an embodiment of the disclosure, a processor (e.g., the processor 120 of FIG. 1), memory (e.g., the memory 130 of FIG. 1), and/or an interface (e.g., the interface 277 of FIG. 1) may be mounted on the printed circuit board 260. According to an embodiment of the disclosure, the printed circuit board 260 may include the first printed circuit board 262 disposed in the first housing 210 and a second printed circuit board 264 disposed in the second housing 220.

According to an embodiment of the disclosure, the flexible printed circuit board 270 may electrically connect a component (e.g., the first printed circuit board 262) positioned in the first housing 210 with a component (e.g., the first printed circuit board 262) positioned in the second housing 220. According to an embodiment of the disclosure, at least a portion of the flexible printed circuit board 270 may cross the hinge cover 240 and/or the hinge structure 280. For example, a portion of the flexible printed circuit board 270 may be disposed in the first housing 210, and another portion thereof may be disposed in the second housing 220.

According to an embodiment of the disclosure, the hinge structure 280 may be connected to the first housing 210 and the second housing 220. According to an embodiment of the disclosure, the first housing 210 may rotate about the second housing 220 by the hinge structure 280. According to an embodiment of the disclosure, the hinge structure 280 may rotatably connect the first housing 210 and the second housing 220 from a folded state (e.g., FIG. 3) to an unfolded state (e.g., FIG. 2).

According to an embodiment of the disclosure, the hinge structure 280 may include a plurality of hinge structures 280-1 and 280-2 disposed in parallel. For example, the hinge structure 280 may include a first hinge structure 280-1 and a second hinge structure 280-2 spaced apart from the first hinge structure 280-1. According to an embodiment of the disclosure, the first hinge structure 280-1 may be symmetrical with the second hinge structure 280-2 with respect to the length direction (e.g., the Y-axis direction) of the electronic device 200.

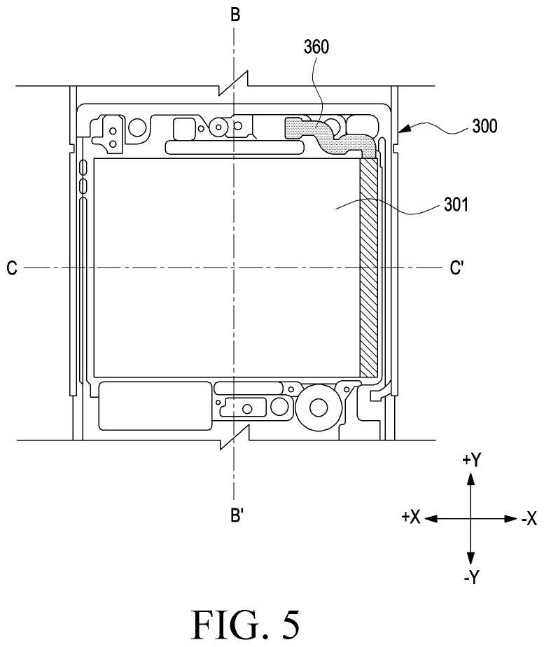

FIG. 5 is a plan view illustrating a supporting member and a battery according to an embodiment of the disclosure.

A supporting member 300 (e.g., the second supporting member 222 of FIG. 4) and a battery 301 (e.g., the first battery 252 or the second battery 254 of FIG. 4) disclosed in FIG. 5 may be identical or similar to the second supporting member 222 and the second battery 254 disclosed in FIG. 4. Therefore, a description of the same components may be omitted.

Referring to FIG. 5, according to an embodiment of the disclosure, the battery 301 may be disposed on the supporting member 300. The battery 301 may be electrically connected to a battery connection member 360. The battery connection member 360 may be electrically connected to a printed circuit board (e.g., the printed circuit board 260 of FIG. 4) and/or a flexible printed circuit board (e.g., the flexible printed circuit board 270 of FIG. 4). As the battery 301 is electrically connected to the printed circuit board 260 and/or the flexible printed circuit board 270 through the battery connection member 360, the electronic device (e.g., the electronic device 200 of FIG. 4) may receive power required for driving from the battery 301.

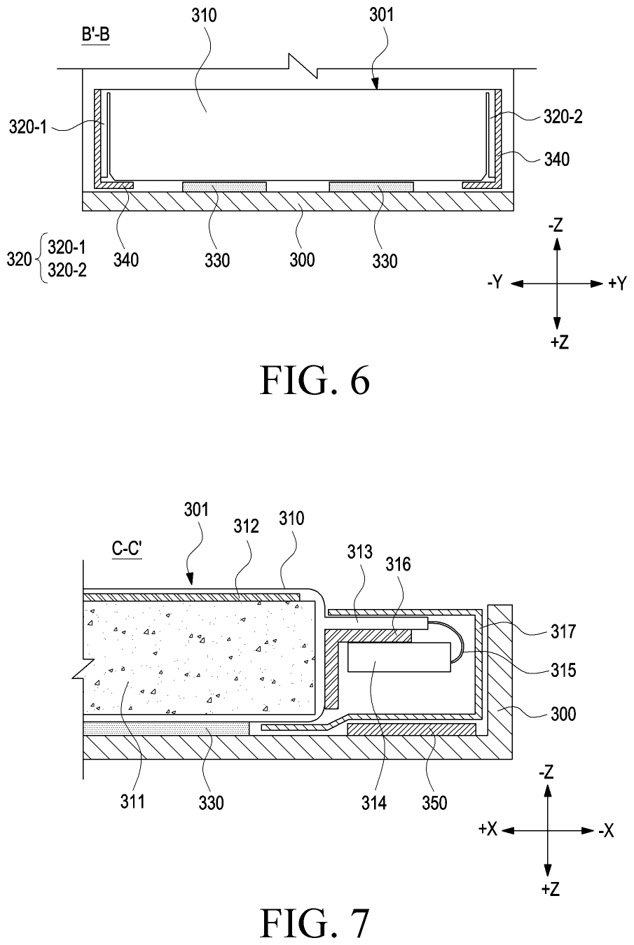

FIG. 6 is a cross-sectional view illustrating the battery 301 of FIG. 5, taken along B-B′ according to an embodiment of the disclosure.

FIG. 7 is a cross-sectional view illustrating the battery 301 of FIG. 5, taken along C-C′ according to an embodiment of the disclosure.

The supporting member 300 (e.g., the second supporting member 222 of FIG. 4) and the battery 301 (e.g., the first battery 252 or the second battery 254 of FIG. 4) disclosed in FIGS. 6 and 7 may be identical or similar to the supporting member 300 and the battery 301 disclosed in FIG. 5. Therefore, a description of the same components may be omitted.

Referring to FIG. 6, according to an embodiment of the disclosure, the battery 301 may include a battery main body 310, a bending area 320, a first attachment member 330, and a second attachment member 340.

According to an embodiment of the disclosure, the first attachment member 330 may be disposed on one surface (+Z-axis direction) of the battery main body 310. According to an embodiment of the disclosure, a display (e.g., the display 230 of FIG. 4) may be disposed in one direction (+Z-axis direction) of the battery main body 310. According to an embodiment of the disclosure, the first attachment member 330 may be disposed between the display 230 and the battery main body 310. The first attachment member 330 disposed on at least a portion of the battery main body 310 may be attached to the battery main body 310. The first attachment member 330 may be attached to at least a portion of the supporting member 300. Accordingly, the battery main body 310 may be attached and fixed to the supporting member 300 by the first attachment member 330. The thickness of the first attachment member 330 may be about 0.08 mm. The first attachment member 330 may be disposed to be spaced apart from the second attachment member 340 to be described below by a predetermined interval.

According to an embodiment of the disclosure, the battery main body 310 may have a rectangular parallelepiped shape. The height (Z-axis direction) of the battery main body 310 may be about 4 mm to about 5 mm. The battery main body 310 may be formed to receive a battery cell (e.g., a battery cell 311 of FIG. 7) to be described below. The bending area 320 may be formed on two opposite sides of the battery main body 310 in the width direction (Y-axis direction).

According to an embodiment of the disclosure, the bending area 320 may be formed to be connected to one end of the battery main body 310 in the height direction (−Z-axis direction). The bending area 320 may include a first bending area 320-1 and a second bending area 320-2. According to an embodiment of the disclosure, the first bending area 320-1 may be formed on one side (−Y-axis direction) of the battery main body 310 in the width direction, and the second bending area 320-2 may be formed on the other side (+Y-axis direction) of the battery main body 310 in the width direction.

According to an embodiment of the disclosure, the first bending area 320-1 may be formed on one side (−Y-axis direction) of the battery main body 310 in the width direction and may be bent toward one side (+Z-axis direction) in the height direction. According to an embodiment of the disclosure, the first bending area 320-1 may be formed to be bent once. The second attachment member 340 may be disposed on at least a portion of one surface (−Y-axis direction) of the first bending area 320-1. The second attachment member 340 may be disposed on at least a portion of the first bending area 320-1 and at least a portion of one surface (+Z-axis direction) of the battery main body 310. As the second attachment member 340 is disposed on at least a portion of the first bending area 320-1 and at least a portion of the battery main body 310, the distance between the first bending area 320-1 and the battery main body 310 may be prevented from increasing. The thickness of the second attachment member 340 may be about 0.05 mm.

According to an embodiment of the disclosure, the second bending area 320-2 may be formed on one side (+Y-axis direction) in the width direction of the battery main body 310 to be bent toward one side (+Z-axis direction) in the height direction. According to an embodiment of the disclosure, the second bending area 320-2 may be formed to be bent once. The second attachment member 340 may be disposed on at least a portion of the other surface (+Y-axis direction) of the second bending area 320-2. The second attachment member 340 may be disposed on at least a portion of the second bending area 320-2 and at least a portion of one surface (+Z-axis direction) of the battery main body 310. As the second attachment member 340 is disposed on at least a portion of the second bending area 320-2 and at least a portion of the battery main body 310, the distance between the second bending area 320-2 and the battery main body 310 may be prevented from increasing. The thickness of the second attachment member 340 may be about 0.05 mm.

According to an embodiment of the disclosure, as the second attachment member 340 is disposed on at least a portion of the first bending area 320-1, at least a portion of the second bending area 320-2, and at least a portion of the battery main body 310, but is not disposed on the other surface (−Z-axis direction) of the battery main body 310, the height (Z-axis direction) of the battery main body 310 may be increased. The increased height (Z-axis direction) of the battery main body 310 may be about 0.05 mm corresponding to the thickness of the second attachment member 340. As the height (Z-axis direction) of the battery main body 310 increases, the volume of the battery main body 310 may increase, and as the volume of the battery main body 310 increases, the capacity of the battery may increase. As the capacity of the battery increases, the usage time of the electronic device 200 may increase, thereby enhancing user convenience.

Referring to FIG. 7, according to an embodiment of the disclosure, the battery cell 311 and a battery protective material 312 may be disposed inside the battery main body 310, and a terrace 313 formed to face in one direction (−X-axis direction) may be formed on one side (−X-axis direction) of the battery main body 310.

According to an embodiment of the disclosure, the battery protective material 312 may be disposed on one side (−Z-axis direction) inside the battery main body 310, and the battery cell 311 may be disposed on one side (+Z-axis direction) of the battery protective material 312. As the battery protective material 312 is disposed on one side (−Z-axis direction) of the battery cell 311, even when an impact is applied to the electronic device 200, the battery protective material 312 may absorb the impact to protect the battery cell 311.

According to an embodiment of the disclosure, as the first attachment member 330 is disposed on at least a portion of one surface (+Z-axis direction) of the battery main body 310, the battery main body 310 may be fixed to the supporting member 300.

According to an embodiment of the disclosure, an adhesive member 316 may be disposed on at least a portion (+Z-axis direction) of the terrace 313 formed on the battery main body 310. As the adhesive member 316 and a battery circuit 314 are bonded to each other, the battery circuit 314 may be disposed to be bonded to the terrace 313. The battery circuit 314 may be electrically connected to the battery cell 311 by a battery connection cable 315. The battery circuit 314 may include a protection circuit module (PCM). The protection circuit module may protect the battery 301 from overcurrent and overdischarge. The battery circuit 314 may be represented as a printed circuit board.

According to an embodiment of the disclosure, a finishing member 317 may be disposed on at least a portion of the terrace 313 (in the −Z-axis direction). The finishing member 317 may be disposed on at least a portion of the terrace 313 (in the −Z-axis direction) and at least a portion of one surface of the battery main body 310 (in the +Z-axis direction) to protect the battery circuit 314 and the battery connection cable 315.

According to an embodiment of the disclosure, a buffer member 350 may be disposed between the finishing member 317 and the supporting member 300. According to an embodiment of the disclosure, the buffer member 350 may be disposed in one direction (+Z-axis direction) of the battery circuit 314. The buffer member 350 may be disposed between the battery circuit 314 and the supporting member 300 to reduce an impact transferred from the supporting member 300 to the battery circuit 314. According to an embodiment of the disclosure, the buffer member 350 may be disposed between the finishing member 317 and the supporting member 300 to reduce the impact transferred to the battery circuit 314. As the buffer member 350 is disposed between the finishing member 317 and the supporting member 300, the step caused by the thickness of the first attachment member 330 attached to the supporting member 300 may be reduced. Accordingly, the stability of the component disposed inside the electronic device 200 may increase.

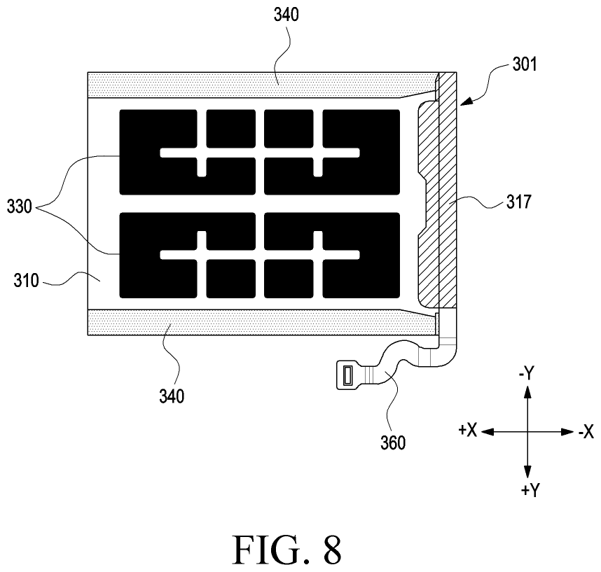

FIG. 8 is a bottom view illustrating a battery according to an embodiment of the disclosure.

The battery 301, the battery main body 310, the finishing member 317, the first attachment member 330, and the second attachment member 340 disclosed in FIG. 8 may be identical or similar to the battery 301, the battery main body 310, the finishing member 317, the first attachment member 330, and the second attachment member 340 disclosed in FIGS. 5, 6, and 7. Therefore, a description of the same components may be omitted.

Referring to FIG. 8, according to an embodiment of the disclosure, the battery 301 may include a battery main body 310, a finishing member 317, a first attachment member 330, and a second attachment member 340. The first attachment member 330 may be disposed on one surface (+Z-axis direction) of the battery main body 310 (see FIG. 7). The second attachment members 340 may be disposed on two opposite sides (Y-axis direction) of the battery main body 310. The first attachment member 330 and the second attachment member 340 may be disposed to be spaced apart from each other by a predetermined interval. According to an embodiment of the disclosure, the first attachment member 330 and the second attachment member 340 may be disposed to be spaced apart from each other by about 2 mm. The finishing member 317 may be disposed on one side (−X-axis direction) of the battery main body 310. The first attachment member 330 and the finishing member 317 may be disposed to be spaced apart from each other by a predetermined interval. According to an embodiment of the disclosure, the first attachment member 330 and the finishing member 317 may be disposed to be spaced apart from each other by about 3 mm.

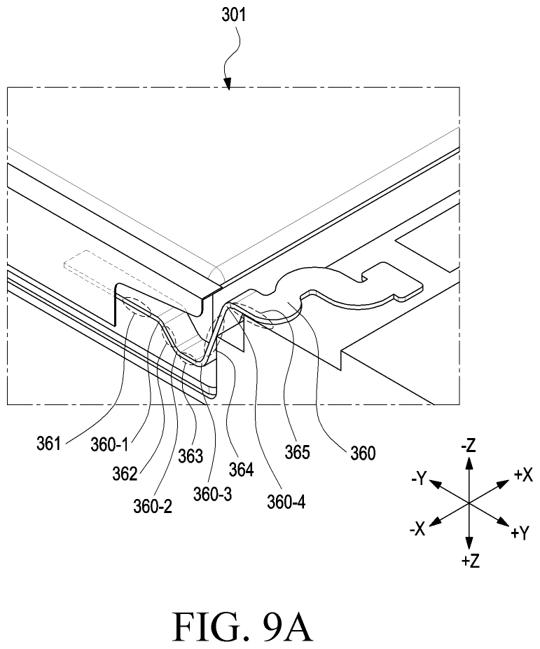

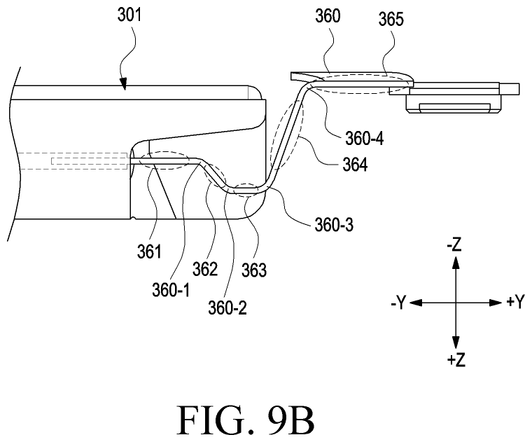

According to an embodiment of the disclosure, the battery connection member 360 may be electrically connected to the battery 301. According to an embodiment of the disclosure, the battery connection member 360 may be connected to a battery circuit (the battery circuit 314 of FIG. 7) of the battery 301. The battery connection member 360 is described below with reference to FIGS. 9A and 9B.

FIG. 9A is a perspective view illustrating a portion of a battery according to an embodiment of the disclosure, and FIG. 9B is a plan view illustrating a portion of a battery according to an embodiment of the disclosure.

The battery 301 and the battery connection member 360 disclosed in FIGS. 9A and 9B may be identical or similar to the battery 301 and the battery connection member 360 disclosed in FIGS. 5, 6, 7, and 8. Therefore, a description of the same components may be omitted.

Referring to FIGS. 9A and 9B, according to an embodiment of the disclosure, the battery 301 may be electrically connected to the battery connection member 360. According to an embodiment of the disclosure, the battery connection member 360 may be electrically connected to a battery circuit (e.g., the battery circuit 314 of FIG. 7) of the battery 301.

According to an embodiment of the disclosure, the battery connection member 360 may include a first portion 361, a second portion 362, a third portion 363, a fourth portion 364, and a fifth portion 365. A first bending portion 360-1 may be formed between the first portion 361 and the second portion 362, a second bending portion 360-2 may be formed between the second portion 362 and the third portion 363, a third bending portion 360-3 may be formed between the third portion 363 and the fourth portion 364, and a fourth bending portion 360-4 may be formed between the fourth portion 364 and the fifth portion 365.

According to an embodiment of the disclosure, the first portion 361 may be formed to extend in the width direction (+Y-axis direction) of the battery 301, and the first bending portion 360-1 formed at one end portion (+Y-axis direction) of the first portion 361 may be bent in the height direction (+Z-axis direction) and the width direction (+Y-axis direction) of the battery 301.

According to an embodiment of the disclosure, the second portion 362 extending from the first bending portion 360-1 may be disposed to face between the +Y-axis direction and the +Z-axis direction or to face between the −Y-axis direction and the −Z-axis direction on a plane formed by the Y-axis and the Z-axis. The second bending portion 360-2 formed at one end portion (+Y-axis direction) of the second portion 362 may be formed to be bent in the width direction (+Y-axis direction) of the battery 301.

According to an embodiment of the disclosure, the third portion 363 extending from the second bending portion 360-2 may be disposed to face in the +Y-axis direction. The third bending portion 360-3 formed at one end portion (+Y-axis direction) of the third portion 363 may be formed to be bent in the height direction (−Z-axis direction) and the width direction (+Y-axis direction) of the battery 301.

According to an embodiment of the disclosure, the third portion 363 extending from the third bending portion 360-3 may be disposed to face between the +Y-axis direction and the −Z-axis direction or to face between the −Y-axis direction and the +Z-axis direction on a plane formed by the Y-axis and the Z-axis. The fourth bending portion 360-4 formed at one end portion (+Y-axis direction) of the third portion 363 may be formed to be bent in the width direction (+Y-axis direction) of the battery 301.

According to an embodiment of the disclosure, the fifth portion 365 extending from the fourth bending portion 360-4 may be disposed on a plane formed by the X-axis and the Y-axis.

According to an embodiment of the disclosure, as the first bending portion 360-1, the second bending portion 360-2, the third bending portion 360-3, and the fourth bending portion 360-4 are formed in the battery connection member 360, the shape of the battery connection member 360 may be “U”. As the battery connection member 360 is formed in a “U” shape, the degree of freedom of the battery connection member 360 may be enhanced. Accordingly, even when the battery 301 moves with respect to the second supporting member (e.g., the supporting member 300 of FIG. 7), the battery 301 may stably supply power to the electronic device (e.g., the electronic device 200 of FIG. 4) through the battery connection member 360.

According to an embodiment of the disclosure, as at least one of the first bending portion 360-1, the second bending portion 360-2, the third bending portion 360-3, and the fourth bending portion 360-4 is formed in the battery connection member 360, the shape of the battery connection member 360 may be a “V”. As the battery connection member 360 is formed in a “V” shape, the degree of freedom of the battery connection member 360 may be enhanced. Accordingly, even when the battery 301 moves with respect to the second supporting member (e.g., the supporting member 300 of FIG. 7), the battery 301 may stably supply power to the electronic device (e.g., the electronic device 200 of FIG. 4) through the battery connection member 360.

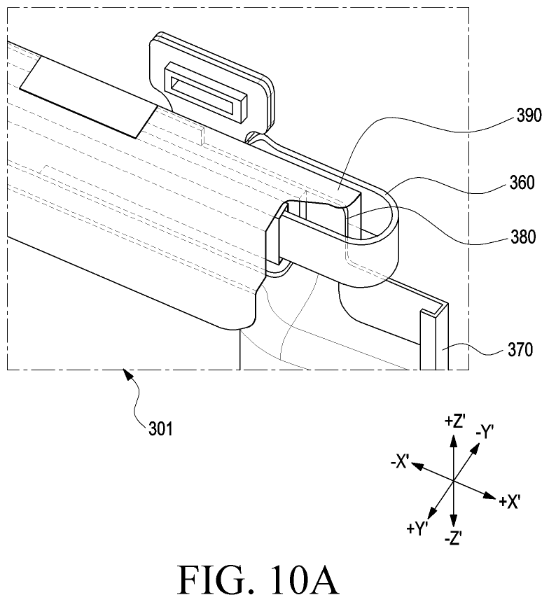

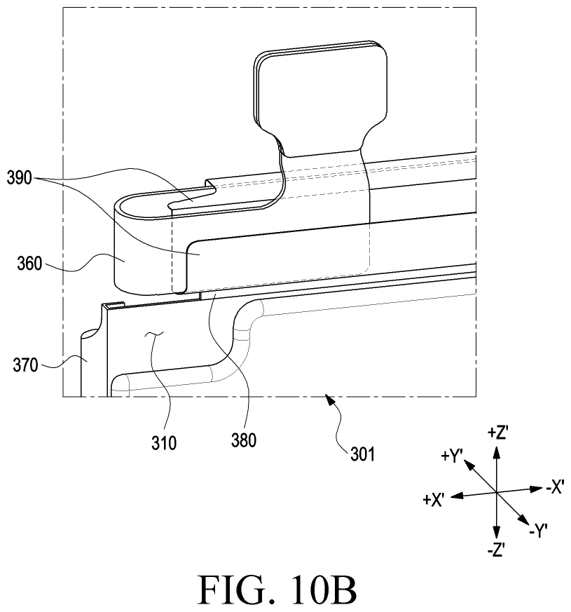

FIG. 10A is a perspective view illustrating a portion of a battery according to an embodiment of the disclosure, and FIG. 10B is a perspective view illustrating another portion of a battery according to an embodiment of the disclosure.

The battery 301 and the battery connection member 360 disclosed in FIGS. 10A and 10B may be identical or similar to the battery 301 and the battery connection member 360 disclosed in FIGS. 5, 6, 7, 8, 9A, and 9B. Therefore, a description of the same components may be omitted.

According to an embodiment of the disclosure, a first guide 370 may be formed on a side surface of the battery 301. The first guide 370 may mitigate the impact transferred from the outside to the battery 301. According to an embodiment of the disclosure, the first guide 370 may mitigate the impact transferred from a side surface of the battery 301 to the battery 301.

According to an embodiment of the disclosure, the battery 301 may be connected to the battery connection member 360. A second guide 380 may be formed in one direction (+Z axis direction) of the battery 301. The second guide 380 may mitigate the impact transferred from the outside to the battery 301 and/or the battery connection member 360. According to an embodiment of the disclosure, a battery circuit (e.g., the battery circuit 314 of FIG. 7) may be disposed on the second guide 380.

According to an embodiment of the disclosure, the battery connection member 360 may be disposed inside the battery 301 with respect to one direction (X′-axis direction). According to an embodiment of the disclosure, one end (+X′ axis direction) of the second guide 380 may be disposed in the −X axis direction more than the first guide 370. As one end (+X′ axis direction) of the second guide 380 is disposed in the −X′ axis direction more than the first guide 370, the battery connection member 360 may be disposed in the −X axis direction more than the first guide 370. As the battery connection member 360 is disposed in the −X′-axis direction more than the first guide 370, a space in which the battery connection member 360 is bent may be secured. Accordingly, the degree of freedom of the battery connection member 360 may be further enhanced.

According to an embodiment of the disclosure, a chamfered area may be formed on one surface (−Y′-axis direction) of the battery 301. According to an embodiment of the disclosure, the shape of the chamfered area is not limited, and may be formed to have a size corresponding to the bent space of the battery connection member 360. According to an embodiment of the disclosure, the chamfered area may be formed at a position adjacent to the battery connection member 360. For example, the chamfered area may be formed in a portion of the battery 301 adjacent to the bent portion of the battery connection member 360. As the chamfered area is formed at a position adjacent to the battery connection member 360, a battery cell (not shown) embedded in the battery 301 may be spaced apart from the outer periphery of the battery 301 to secure stability of the battery 301.

According to an embodiment of the disclosure, a finishing tape 390 may be disposed on at least a portion of the battery 301. The finishing tape 390 may be disposed in one direction (+Z′ axis direction) of the battery 301. The finishing tape 390 may be disposed in one direction (+Z′ axis direction) of the battery 301 to surround at least a portion of the battery connection member 360 and at least a portion of the second guide 380. Accordingly, as the finishing tape 390 is disposed to surround the battery connection member 360 and the second guide 380, it is possible to prevent the battery connection member 360 and the second guide 380 from contacting other components inside the electronic device 200.

According to an embodiment of the disclosure, at least a portion of the finishing tape 390 may be disposed to be bent to face, and the battery connection member 360 may be disposed between at least the portion of the finishing tape 390 that is bent to face. Accordingly, at least a portion of the battery connection member 360 may be protected from impact by the finishing tape 390.

In order to mount a larger-capacity battery in an electronic device, the size of the space in which the battery is disposed needs to be increased. However, as the size of the space in which the battery is disposed increases, the electronic device is difficult to downsize, and user convenience may be reduced. Therefore, there is a need for a method capable of maintaining the size of an electronic device while having a high-capacity battery.

Various embodiments of the disclosure may provide a battery having a high capacity relative to the same volume (the volume of the space in which the battery is disposed).

According to an embodiment of the disclosure, as the bending area of the battery is disposed to face in the direction in which the display is disposed, the attachment member is disposed on one surface of the battery and a side surface between the one surface and the other surface, and the attachment member is not disposed on the other surface, the space in which the attachment member is not disposed may have a margin. As the capacity of the battery is increased by increasing the size of the battery in the space generated as the attachment member is not disposed, the usage time of the electronic device may be increased.

According to an embodiment of the disclosure, an electronic device (e.g., the electronic device 200 of FIG. 2) may comprise a housing (e.g., the housing 202 of FIG. 2), a display (e.g., the display 230 of FIG. 2) disposed in the housing, a supporting member (e.g., the supporting member 300 of FIG. 5) disposed inside the housing, a battery (e.g., the second battery 254 of FIG. 6) disposed on the supporting member and including a first surface facing the display, a second surface facing in a direction opposite to the first surface, and a side surface between the first surface and the second surface, a first attachment member (e.g., the first attachment member 330 of FIG. 6) disposed on a first area of the first surface to fix the battery to the supporting member, and a second attachment member (e.g., the second attachment member 340 of FIG. 6) including a first portion disposed on a second area of the first surface and a second portion disposed to surround at least a portion of the side surface. The battery may include at least one bending area (e.g., the bending area 320 of FIG. 6) extending from the first surface of the battery and bent toward the display.

According to an embodiment of the disclosure, a terrace (e.g., the terrace 313 of FIG. 7) extending from the side surface may be formed.

According to an embodiment of the disclosure, the electronic device may further comprise a printed circuit board (e.g., the battery circuit 314 of FIG. 7) disposed on the terrace. A protection circuit module (PCM) may be disposed on the printed circuit board.

According to an embodiment of the disclosure, the electronic device may further comprise a battery connection member (e.g., the battery connection member 360 of FIG. 9B) connected to the printed circuit board and connected in an order of a first portion (e.g., the first portion 361 of FIG. 9B), a second portion (e.g., the second portion 362 of FIG. 9B), a third portion (e.g., the third portion 363 of FIG. 9B), a fourth portion (e.g., the fourth portion 364 of FIG. 9B), and a fifth portion (e.g., the fifth portion 365 of FIG. 9B). The battery connection member may include a first bending portion (e.g., the first bending portion 360-1 of FIG. 9B) formed between the first portion and the second portion, a second bending portion (e.g., the second bending portion 360-2 of FIG. 9B) formed between the second portion and the third portion, a third bending portion (e.g., the third bending portion 360-3 of FIG. 9B) formed between the third portion and the fourth portion, and a fourth bending portion (e.g., the fourth bending portion 360-4 of FIG. 9B) formed between the fourth portion and the fifth portion.

According to an embodiment of the disclosure, the electronic device may further comprise a buffer member (e.g., the buffer member 350 of FIG. 7) disposed between the printed circuit board and the supporting member.

According to an embodiment of the disclosure, the battery connection member may be formed in a U shape.

According to an embodiment of the disclosure, the electronic device may further comprise a battery protective material (e.g., the battery protective material 312 of FIG. 7) disposed inside the battery and disposed adjacent to the second surface.

According to an embodiment of the disclosure, the first attachment member and the second attachment member may be spaced apart from each other by a predetermined interval.

According to an embodiment of the disclosure, the electronic device may further comprise a chamfered area formed on one surface of the battery.

According to an embodiment of the disclosure, the bending area may be formed to be bent once.

According to an embodiment of the disclosure, a battery (e.g., The second battery 254 of FIG. 6) may comprise a first surface, a second surface facing in a direction opposite to the first surface, a side surface between the first surface and the second surface, a first attachment member (e.g., The first attachment member 330 of FIG. 6) disposed in a first area of the first surface, a second attachment member (e.g., The second attachment member 340 of FIG. 6) including a first portion disposed in a second area of the first surface and a second portion disposed to surround at least a portion of the side surface, and at least one bending area (e.g., The bending area 320 of FIG. 6) extending from the first surface and bent toward the second surface.

According to an embodiment of the disclosure, a terrace (e.g., the terrace 313 of FIG. 7) extending from the side surface may be formed.

According to an embodiment of the disclosure, the battery may further comprise a printed circuit board (e.g., the battery circuit 314 of FIG. 7) disposed on the terrace. A protection circuit module (PCM) may be disposed on the printed circuit board.

According to an embodiment of the disclosure, the battery may further comprise a battery connection member (e.g., the battery connection member 360 of FIG. 9B) connected to the printed circuit board and connected in an order of a first portion (e.g., the first portion 361 of FIG. 9B), a second portion (e.g., the second portion 362 of FIG. 9B), a third portion (e.g., the third portion 363 of FIG. 9B), a fourth portion (e.g., the fourth portion 364 of FIG. 9B), and a fifth portion (e.g., the fifth portion 365 of FIG. 9B). The battery connection member may include a first bending portion (e.g., the first bending portion 360-1 of FIG. 9B) formed between the first portion and the second portion, a second bending portion (e.g., the second bending portion 360-2 of FIG. 9B) formed between the second portion and the third portion, a third bending portion (e.g., the third bending portion 360-3 of FIG. 9B) formed between the third portion and the fourth portion, and a fourth bending portion (e.g., the fourth bending portion 360-4 of FIG. 9B) formed between the fourth portion and the fifth portion.

According to an embodiment of the disclosure, the battery connection member may be formed in a U shape.

According to an embodiment of the disclosure, the battery may further comprise a battery protective material (e.g., the battery protective material 312 of FIG. 7) disposed inside the battery and disposed adjacent to the second surface.

According to an embodiment of the disclosure, the first attachment member and the second attachment member may be spaced apart from each other by a predetermined interval.

According to an embodiment of the disclosure, the battery may further comprise a chamfered area formed on one surface of the battery.

According to an embodiment of the disclosure, the bending area may be formed to be bent once.

According to an embodiment of the disclosure, the battery may further comprise a finishing member (e.g., the finishing member 317 of FIG. 7) disposed on at least a portion of the terrace and formed to surround the printed circuit board.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing;
a display disposed at the housing;
a supporting member disposed in the housing;
a battery disposed on the supporting member and including a first surface facing the display, a second surface facing in a direction opposite to the first surface, and a side surface disposed between the first surface and the second surface;
a first attachment member disposed on a first area of the first surface to fix the battery to the supporting member; and
a second attachment member including a first portion disposed on a second area of the first surface and a second portion disposed to surround at least a portion of the side surface,
wherein the battery includes at least one bending area extending from the first surface of the battery and bent toward the display.

2. The electronic device of claim 1, wherein a terrace extending from the side surface is formed.

3. The electronic device of claim 2, further comprising a printed circuit board disposed on the terrace and a protection circuit module (PCM) disposed on the printed circuit board.

4. The electronic device of claim 3, further comprising:
a battery connection member connected to the printed circuit board and connected in an order of a first portion, a second portion, a third portion, a fourth portion, and a fifth portion,
wherein the battery connection member includes a first bending portion formed between the first portion and the second portion, a second bending portion formed between the second portion and the third portion, a third bending portion formed between the third portion and the fourth portion, and a fourth bending portion formed between the fourth portion and the fifth portion.

5. The electronic device of claim 4, further comprising a buffer member disposed between the printed circuit board and the supporting member.

6. The electronic device of claim 4, wherein the battery connection member is formed in a U shape.

7. The electronic device of claim 1, further comprising a battery protective material disposed in the battery and disposed adjacent to the second surface.

8. The electronic device of claim 1, wherein the first attachment member and the second attachment member are spaced apart from each other by a predetermined interval.

9. The electronic device of claim 1, further comprising a chamfered area formed on one surface of the battery.

10. The electronic device of claim 1, wherein the bending area is formed to be bent once.

11. A battery comprising:
a first surface;
a second surface facing in a direction opposite to the first surface;
a side surface disposed between the first surface and the second surface;
a first attachment member disposed on a first area of the first surface;
a second attachment member including a first portion disposed on a second area of the first surface and a second portion disposed to surround at least a portion of the side surface; and
at least one bending area extending from the first surface and bent toward the second surface.

12. The battery of claim 11, wherein a terrace extending from the side surface is formed.

13. The battery of claim 12, further comprising a printed circuit board disposed on the terrace and a protection circuit module (PCM) disposed on the printed circuit board.

14. The battery of claim 13, further comprising:
a battery connection member connected to the printed circuit board and connected in an order of a first portion, a second portion, a third portion, a fourth portion, and a fifth portion,
wherein the battery connection member includes a first bending portion formed between the first portion and the second portion, a second bending portion formed between the second portion and the third portion, a third bending portion formed between the third portion and the fourth portion, and a fourth bending portion formed between the fourth portion and the fifth portion.

15. The battery of claim 14, further comprising a buffer member disposed between the printed circuit board and a supporting member.

16. The battery of claim 14, wherein the battery connection member is formed in a U shape.

17. The battery of claim 11, further comprising a battery protective material disposed in the battery and disposed adjacent to the second surface.

18. The battery of claim 11, wherein the first attachment member and the second attachment member are spaced apart from each other by a predetermined interval.

19. The battery of claim 11, further comprising a chamfered area formed on one surface of the battery.

20. The battery of claim 11, wherein the bending area is formed to be bent once.
